(19) United States
(12) Patent Application Publication
(10) Pub. No.: US 2021/0331655 A1
(43) Pub. Date: Oct. 28, 2021

(54) METHOD AND DEVICE FOR MONITORING VEHICLE'S BRAKE SYSTEM IN AUTONOMOUS DRIVING SYSTEM

(71) Applicant: LG Electronics Inc., Seoul (KR)

(72) Inventor: Sukkyoung SO, Seoul (KR)

(21) Appl. No.: 16/496,801

(22) PCT Filed: Jul. 8, 2019
(86) PCT No.: PCT/KR2019/008361

§ 371 Date: Sep. 23, 2019

(51) Int. Cl. B60T 8/88; B60T 8/171; B60T 8/174; B60T 17/22; G06N 3/08

(52) U.S. Cl. CPC B60T 8/885; B60T 8/171; B60T 8/174; B60T 17/22; B60T 2270/406; B60T 2210/36; B60T 2250/02; B60T 2250/04; G06N 3/08

(57) ABSTRACT

A method and device for monitoring a vehicle's brake system in an autonomous driving system are disclosed. The method includes: setting criteria information for determining whether the brake system is operating normally; receiving information related to the vehicle's braking; performing neural network training based on the braking-related information; determining whether the brake system is operating normally based on results of the neural network training and the criteria information; and giving feedback to a user based on the determination. According to an exemplary embodiment of the present invention, vehicle driving safety can be ensured by notifying the user in a timely manner that the vehicle's braking-related parts should be replaced or calibrated. In the present invention, one or more among an autonomous vehicle, a user terminal, and a server may be associated with an artificial intelligent module, a drone (unmanned aerial vehicle (UAV)) robot, an augmented reality (AR) device, a virtual reality (VR) device, a 5G service-related device, etc.

### TECHNICAL FIELD

The present invention relates to a method and device for monitoring a vehicle's brake system based on neural network training.

### BACKGROUND ART

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### DISCLOSURE

### Technical Problem

An aspect of the present invention is to propose a method for monitoring a vehicle's brake system by using an AI processor in an autonomous driving system.

Another aspect of the present invention is to provide a method that transmits information on the replacement and calibration of a vehicle's braking-related parts based on the monitoring of the vehicle's brake system.

Technical problems to be solved by the present invention are not limited to the above-mentioned technical problems, and other technical problems not mentioned herein may be clearly understood by those skilled in the art from the description below.

### Technical Solution

An exemplary embodiment of the present invention provides a method for monitoring a vehicle's brake system in an autonomous driving system, the method including: setting criteria information for determining whether the brake system is operating normally; receiving information related to the vehicle's braking; performing neural network training based on the braking-related information; determining whether the brake system is operating normally based on results of the neural network training and the criteria information; and giving feedback to a user based on the determination.

Furthermore, in the method according to the exemplary embodiment of the present invention, the criteria information may be set based on the relationship between the speed and braking distance of the vehicle and the braking power of the brake system.

Furthermore, in the method according to the exemplary embodiment of the present invention, the criteria information may be set in advance by the vehicle's manufacturer.

Furthermore, in the method according to the exemplary embodiment of the present invention, the braking-related information may include at least one among vehicle weight, passenger's weight, passenger's location information, tire air pressure, driving speed, temperature, and road surface conditions.

Furthermore, in the method according to the exemplary embodiment of the present invention, information on the road surface conditions may be created by using the vehicle's lidar.

Furthermore, in the method according to the exemplary embodiment of the present invention, the neural network training may be a deep neural network (DNN) method.

Furthermore, in the method according to the exemplary embodiment of the present invention, the feedback may include a message asking to replace or calibrate the vehicle's braking-related parts.

Furthermore, in the method according to the exemplary embodiment of the present invention, the feedback may be transmitted to the user through either the vehicle's display device or audio equipment.

Furthermore, in the method according to the exemplary embodiment of the present invention, the feedback may further include the location of a vehicle repair shop for having the vehicle's braking-related parts replaced or calibrated and route information.

Furthermore, the method according to the exemplary embodiment of the present invention may further include transmitting to a repair shop information on the vehicle's braking-related parts that need to be replaced or calibrated over a wireless communication network.

Another exemplary embodiment of the present invention provides a device for monitoring a vehicle's brake system in an autonomous driving system, the device including: an interface unit for exchanging signals via wires or wirelessly with at least one electronic device provided within the vehicle; a memory for storing data; and a processor functionally connected to the memory, wherein the processor performs control to set criteria information for determining whether the brake system is operating normally, receive information related to the vehicle's braking, perform neural network training based on the braking-related information, determine whether the brake system is operating normally based on results of the neural network training and the criteria information, and give feedback to a user based on the determination.

Furthermore, in the device according to the exemplary embodiment of the present invention, the criteria information may be set based on the relationship between the speed and braking distance of the vehicle and the braking power of the brake system.

Furthermore, in the device according to the exemplary embodiment of the present invention, the braking-related information may include at least one among vehicle weight, passenger's weight, passenger's location information, tire air pressure, driving speed, temperature, and road surface conditions.

Furthermore, in the device according to the exemplary embodiment of the present invention, the feedback may include a message asking to replace or calibrate the vehicle's braking-related parts.

Furthermore, in the device according to the exemplary embodiment of the present invention, the device may communicate with at least one among a mobile terminal, a network, and a self-driving vehicle other than the device.

### Advantageous Effects

According to an exemplary embodiment of the present invention, it is possible to enhance vehicle driving safety by monitoring a vehicle's brake system based on neural network training using an AI processor in an autonomous driving system and giving the user feedback about safety-related information, such as notifications of the replacement and calibration of the vehicle's braking-related parts (e.g., brake pads, tires, etc.), based on monitoring results.

Furthermore, according to an exemplary embodiment of the present invention, it is possible to increase the user's convenience by transmitting notifications of the replacement and calibration of a vehicle's braking-related parts to the user and making vehicle inspection-related reservations for the user.

The advantageous effects according to an embodiment of the present invention are not limited by what has been exemplified above, and more various advantageous effects are included in the present specification.

### DESCRIPTION OF DRAWINGS

The accompanying drawings, which are included herein as a part of detailed descriptions to help understanding the present invention, provide embodiments of the present invention and describe technical features of the present invention with detailed descriptions below.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram illustrating the interior of a vehicle according to an embodiment of the present invention.

FIG. 10 is a block diagram referred to in description of a cabin system for a vehicle according to an embodiment of the present invention.

FIG. 11 is a diagram referred to in description of a usage scenario of a user according to an embodiment of the present invention.

FIG. 12 shows an example of an operation flowchart of a vehicle operating according to a method and exemplary embodiment proposed in the present invention.

FIG. 13 shows an example of setting a criterion for determining whether a brake system is operating normally, to which a method and exemplary embodiment proposed in the present disclosure are applicable.

FIG. 14 shows an example of performing monitoring of a brake system through neural network training by using a vehicle's AI processor, to which a method and exemplary embodiment proposed in the present disclosure are applicable.

FIG. 15 shows an AI device 1500 according to an exemplary embodiment of the present invention.

FIG. 16 shows an AI device 1600 according to an exemplary embodiment of the present invention.

FIG. 17 shows an AI system 1700 according to an exemplary embodiment of the present invention.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

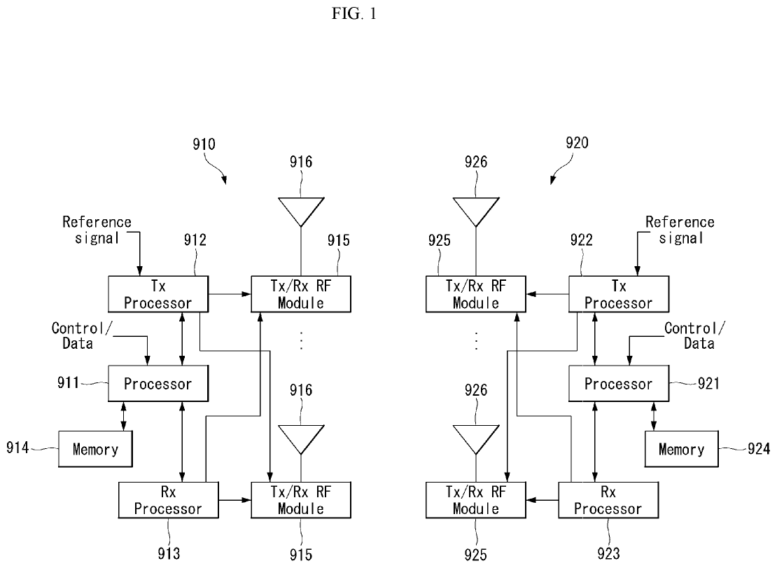

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

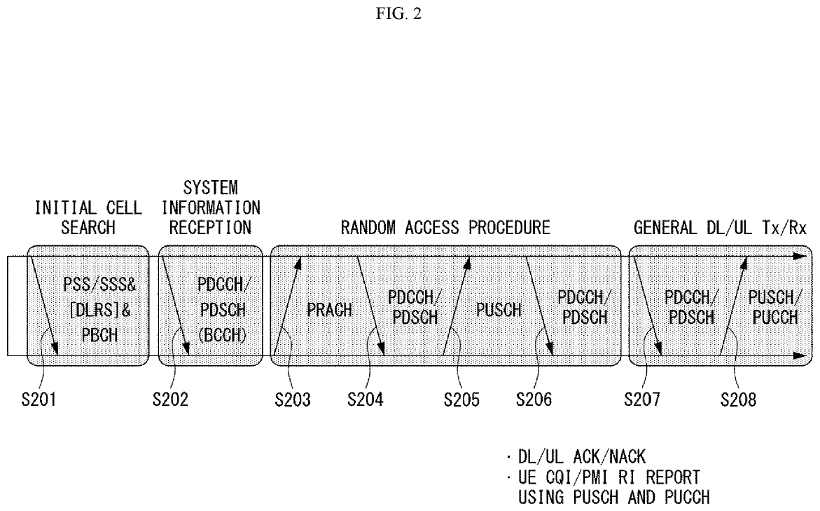

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

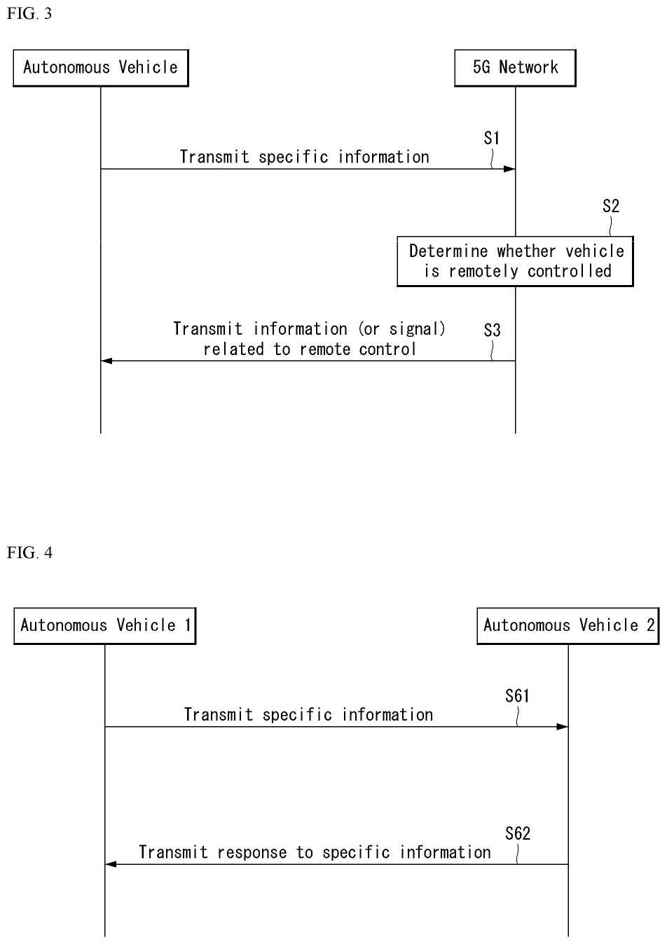

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

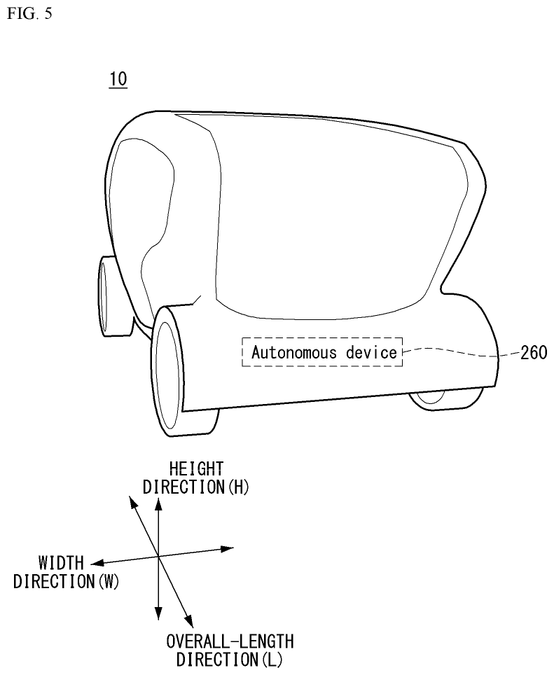

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

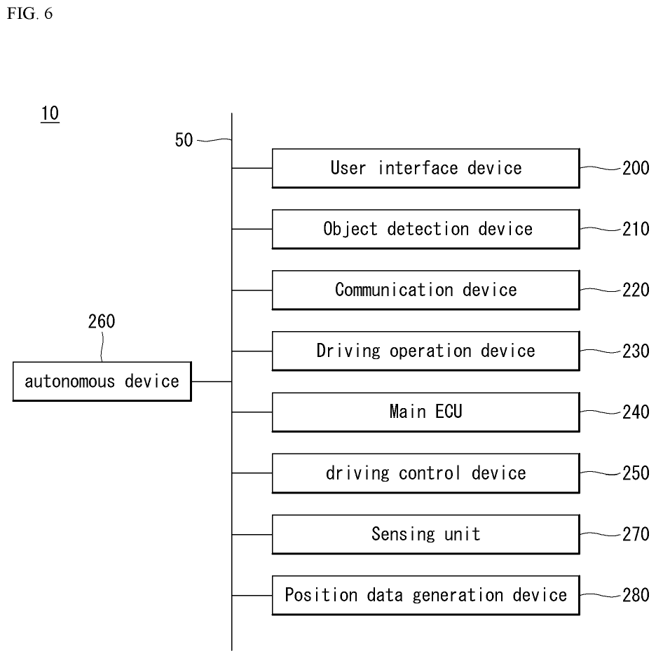

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Driving System

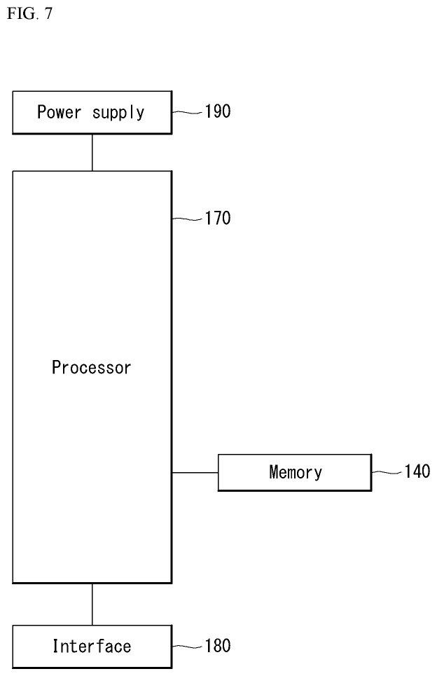

FIG. 7 is a control block diagram of an autonomous driving system according to an exemplary embodiment of the present invention.

Referring to FIG. 7, an autonomous driving system 260 may include a memory 140, a processor 170, an interface unit 180, and a power supply unit 190.

The memory 140 may be electrically connected to the processor 170. The memory 140 may store basic data for each unit, control data for controlling operation of each unit, and input/output data. The memory 140 may include at least one among ROM, RAM, EPROM, flash drive, and hard drive in terms of hardware. The memory 140 may also store various kinds of data for overall operation of the autonomous driving system 260, including a program for processing or controlling the processor 170. The memory 140 may be implemented integrally with the processor 170. In some embodiments, the memory 140 may be classified as a sub-component of the processor 170. In some embodiments, the memory 140 may store various programs required for AI processing, a neural network model (e.g., deep learning model), and data. In some embodiments, the memory 140 may be accessed by an AI processor, and the AI processor may read, write, modify, delete, and update data stored in it.

The interface unit 180 may exchange signals via wires or wirelessly with at least one electronic device provided within the vehicle 10. The interface unit 180 may exchange signals via wires or wirelessly with at least one among an object detection device 210, a communication device 220, an operation handling device 230, a main ECU 240, a driving control device 250, a sensing unit 270, and a location data creation device 280. The interface unit 180 may include at least one among a communication module, a terminal, a pin, a cable, a port, a circuit, an element, and a device.

The power supply unit 190 may supply electric power to the autonomous driving system 260. The power supply unit 190 may take electric power from a power source (e.g., battery) included in the vehicle 10 and supply the electric power to each unit of the autonomous driving system 260. The power supply unit 190 may operate in accordance with control signals provided from the main ECU 240. The power supply unit 190 may include an SMPS (switched-mode power supply).

The processor 170 may be electrically connected to the memory 140, interface unit 180, and power supply unit 190 and exchange signals with them. The processor 170 may be implemented by using at least any of the following: application specific integrated circuits (ASICs), digital signal processors (DSPs), digital signal processing devices (DSPDs), programmable logic devices (PLDs) field programmable gate arrays, processors, controllers, micro-controllers, microprocessors, and electrical units for performing other functions.

The processor 170 may be driven by electric power provided from the power supply unit 190. The processor 170 may receive data, process data, generate signals, and provide signals while being supplied with electric power.

The processor 170 may receive information from other electronic devices within the vehicle 10 through the interface unit 180. The processor 170 may provide control signals to other electronic devices within the vehicle 10 through the interface unit 180.

The processor 170 may include an AI processor 170-1. Alternatively, the processor 170 itself may correspond to an AI processor capable of performing AI processing.

In some embodiments, the AI processor 170-1 may train a neural network by using a program stored in the memory 140. The neural network may be designed to emulate a human brain's structure on a computer, and may include a plurality of network nodes having weights that emulate neurons in a human neural network. The plurality of network nodes may send and receive data through connections so that they emulate the synaptic activity of neurons sending and receiving signals through synapses. Such a neural network may include a deep learning model, which has evolved from a neural network model. In the deep learning model, the plurality of network nodes are arranged in different layers, and may send and receive data through convolutions. Examples of the neural network model include various deep learning techniques such as deep neural networks (DNN), convolutional deep neural networks (CNN), recurrent neural networks (RNN), restricted Boltzmann machines (RBM), deep belief networks (DBN), and deep Q-networks.

In some embodiments, the AI processor 170-1 may include a data learning part 175 for training a neural network for data classification/recognition. The data learning part 175 may learn criteria about which learning data it will use to determine on data classification/recognition and how data is classified and recognized using learning data. The data learning part 175 may train a deep learning model by acquiring learning data to be used in learning and applying the acquired learning data to the deep learning model.

The data learning part 175 may be manufactured in the form of at least one hardware chip and mounted on an AI device 1500 to be described later. For example, the data learning part 175 may be manufactured in the form of a hardware chip dedicated to artificial intelligence (AI), or may be manufactured as part of a general-purpose processor (CPU) or dedicated graphics processor (GPU) and mounted on the AI device 1500. Also, the data learning part 175 may be implemented as a software module. If it is implemented as a software module (or a program module including instructions), the software module may be stored in a non-transitory computer readable medium. In this case, at least one software module may be provided by an OS (operating system) or by an application.

In some embodiments, the data learning part 175 may include a learning data acquisition part 176 and a model training part 177.

The learning data acquisition part 176 may acquire learning data required for a neural network model for classifying and recognizing data. For example, the learning data acquisition part 176 may acquire vehicle data and/or sample data as learning data to feed into the neural network model.

By using the acquired learning data, the model training part 177 may train the neural network model to have criteria for determining how to classify certain data. In this instance, the model training part 177 may train the neural network model through supervised learning which uses at least part of the learning data as the criteria for determination. Alternatively, the model training part 177 may train the neural network model through unsupervised learning which helps find criteria for determination by allowing the neural network model to learn on its own without supervision using the learning data. Also, the model training part 177 may train the neural network model through reinforcement learning by using feedback about whether a right decision is made on a situation by learning. Also, the model training part 177 may train the neural network model by using a learning algorithm including error back-propagation or gradient descent.

Once the neural network model is trained, the model training part 177 may store the trained neural network model in the memory 140. The model training part 177 may store the trained neural network model in a memory of a server connected to the AI device 1500 over a wired or wireless network.

The data learning part 175 may further include a learning data preprocessing part (not shown) and a learning data selection part (not shown), in order to improve analysis results from a recognition model or save the resources or time needed to create the recognition model.

The learning data preprocessing part may preprocess acquired data so that the acquired data is used in learning to decide on a situation. For example, the learning data preprocessing part may process acquired learning data into a preset format to enable the model training part to use the acquired data in learning to recognize images.

Moreover, the learning data selection part may select data required for learning from among the learning data acquired by the learning data acquisition part or the learning data preprocessed by the preprocessing part. The selected learning data may be provided to the model learning part. For example, the learning data selection part may only select data about objects included in a specific area as learning data by detecting the specific area from an image acquired through a camera in the vehicle.

In addition, the data learning part 175 may further include a model evaluation part (not shown) for improving analysis results from the neural network model.

The model evaluation part may feed evaluation data into the neural network model, and, if analysis results produced from the evaluation data do not satisfy a predetermined criterion, may get the model training part to train the neural network model again. In this case, the evaluation data may be data that is defined for evaluating the recognition model. In an example, if the number or proportion of evaluation data from which inaccurate analysis results are produced by analyzing the recognition model trained on the evaluation data exceeds a preset threshold, the model evaluation part may evaluate the analysis results as not satisfying the predetermined criterion.

The above-described AI processor 170-1 may be present within the autonomous driving system 260, independently from the processor 170.

The autonomous driving system 260 may include at least one printed circuit board (PCB). The memory 140, interface unit 180, power supply unit 190, and processor 170 may be electrically connected to a printed circuit board.

(4) Operation of Autonomous Device

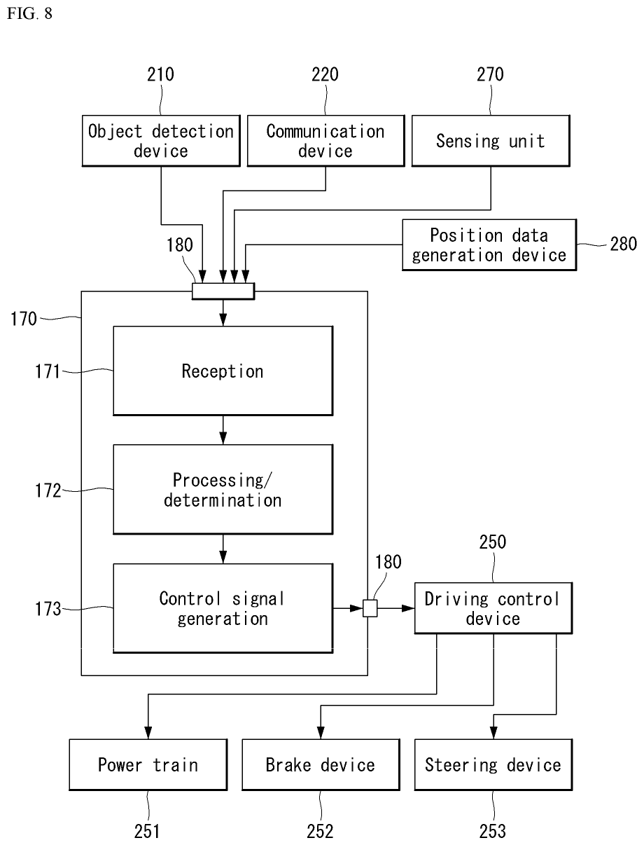

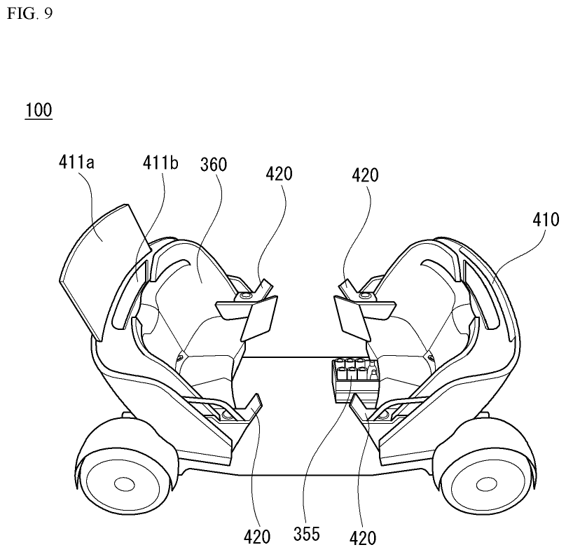

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

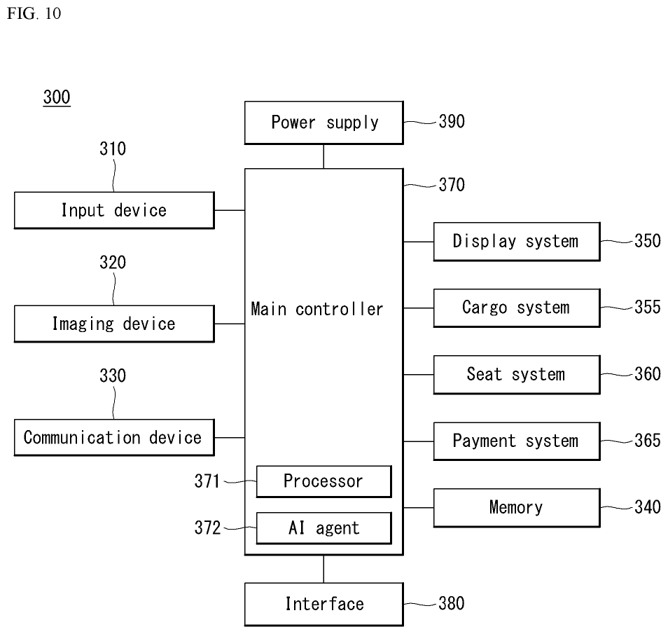

FIG. 9 is a diagram showing the interior of the vehicle according to an embodiment of the present invention. FIG. 10 is a block diagram referred to in description of a cabin system for a vehicle according to an embodiment of the present invention.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats.

The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

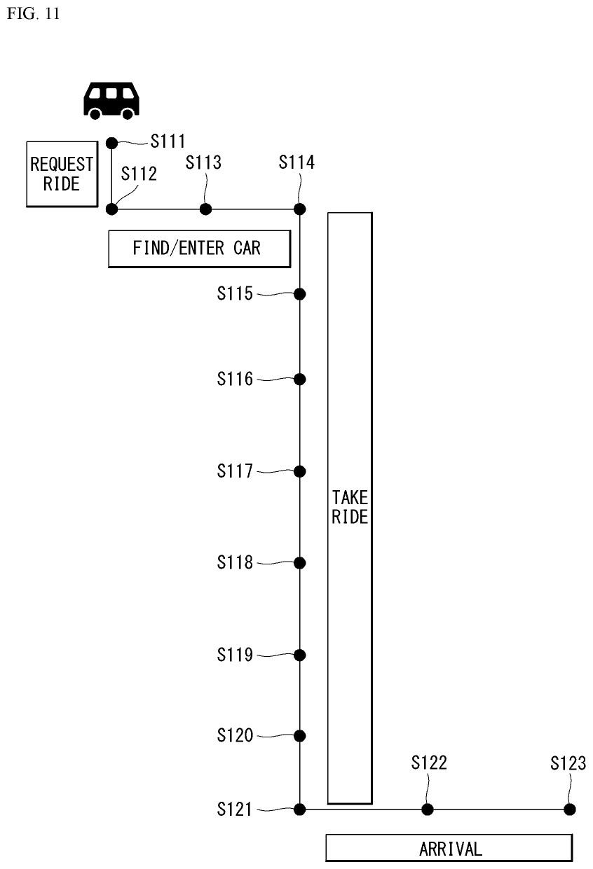

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

### Exemplary Embodiment 1

The user may operate a vehicle's brake input device (e.g. brake pedal), in order to slow down or stop the vehicle. The driving control device 250 of the vehicle 10 may control a brake system for the vehicle according to an input. Here, the brake system for the vehicle refers to a system that stops a running vehicle or keeps the vehicle stopped. The vehicle's brake system may include a hydraulic brake, a servo brake, and an air brake.

In general, when the vehicle's brake system is driven, the vehicle slows down or stops by using friction. Due to friction, the vehicle's braking-related parts such as brake pads and tires wear out. Thus, the vehicle's braking-related parts such as brake pads and tires need to be replaced after a certain time to ensure safety. At present, users can decide when to replace the vehicle's braking-related parts based on distance traveled, experience, etc. However, this depends on the user's experimental decision, which cannot serve as a criterion for making an accurate decision. Moreover, if the vehicle's braking-related parts are not replaced at a proper time, very dangerous accidents may occur. Accordingly, it is very important to provide the user with information about time to replace the vehicle's braking-related parts, time to calibrate them, etc., because such information is critical for ensuring vehicle driving safety.

The present disclosure proposes a method and device for monitoring a vehicle's brake system based on neural network training using an AI processor in an autonomous driving system, decides when to replace a vehicle's braking-related parts such as the vehicle's brake pads, tires, etc. based on monitoring results, and gives the user feedback about this.

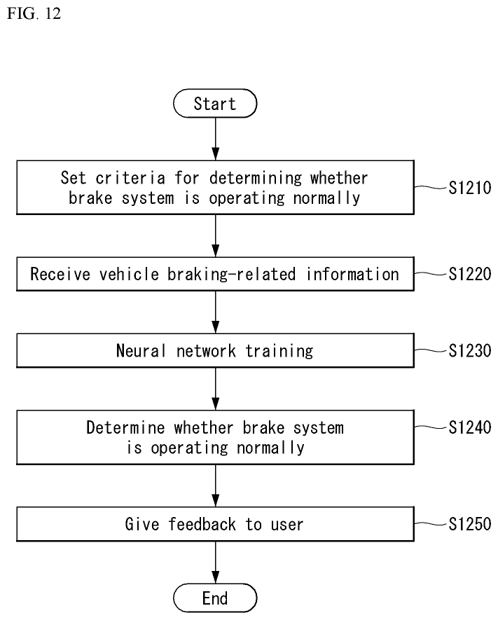

FIG. 12 shows an example of an operation flowchart of a vehicle operating according to a method and exemplary embodiment proposed in the present invention. FIG. 12 is merely for illustrative purposes and does not limit the technical idea of the present invention.

Referring to FIG. 12, there is a need to set a criterion for determining whether the vehicle's braking system is operating normally, in order to monitor the vehicle's braking system. When the user pushes the brake pedal, the braking distance may vary depending on vehicle speed, road surface conditions, and amount of force applied to the brake pedal. Here, braking distance refers to the distance a vehicle will travel from the point when its brake system starts working to when it comes to a complete stop. The criterion for determining whether the vehicle's brake system is operating normally may be set based on the vehicle's speed, the brake system's braking power (e.g. the force, pressure, etc. on the brake pedal), and the braking distance (S1210). The criterion for determining whether the brake system is operating normally may be viewed as determining whether or not the vehicle's braking-related parts such as the brake pads, tires, etc. are within a normal operating range.

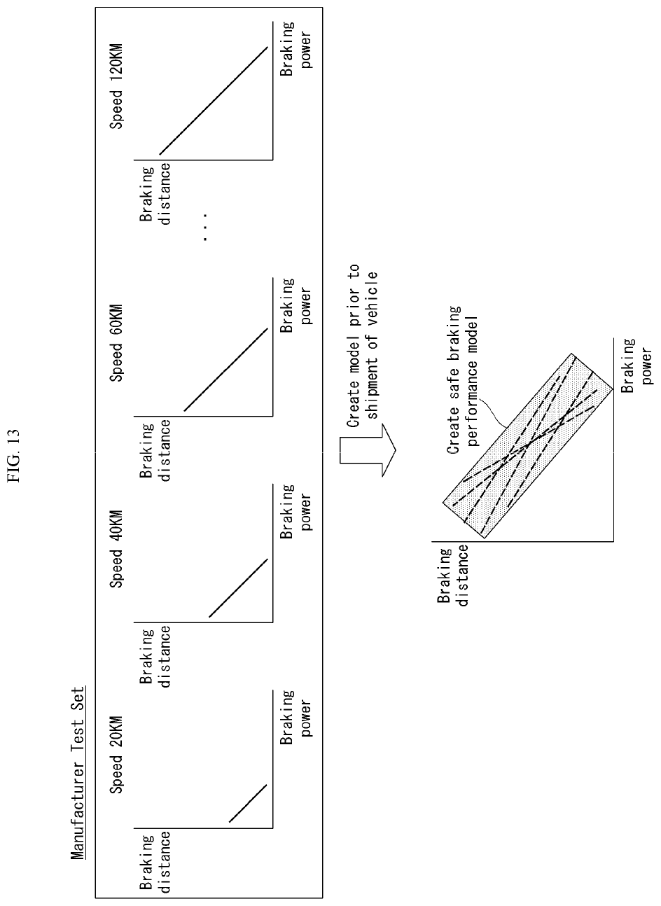

FIG. 13 shows an example of setting a criterion for determining whether a brake system is operating normally, to which a method and exemplary embodiment proposed in the present disclosure are applicable. FIG. 13 is merely for illustrative purposes and does not limit the technical idea of the present invention.

In an example, referring to FIG. 13, the vehicle's manufacturer may perform repeated tests prior to shipment of the vehicle to establish a relationship between the braking distance versus vehicle speed and the braking power of the brake system, and the criterion for determining whether the brake system is operating normally may be set based on this relationship. Hereinafter, the relationship between the braking distance versus each vehicle's speed and the braking power of the brake system is referred to as a “safe braking performance model”. However, this is only for ease of explanation and does not limit the technical idea of the present invention. It is possible to determine whether the brake system is operating normally, based on the safe braking performance model. The safe braking performance model may be used to monitor the vehicle's braking-related parts. The safe braking performance model may be stored in the memory of the autonomous driving system 260 connected to the vehicle's driving control device 250.

The criterion (e.g., safe braking performance model) for determining whether the brake system is operating normally may be set in stages. For example, a first stage may be set to a range in which the brake system operates normally and requires the replacement or calibration of the vehicle's braking-related parts. A second stage may be set to a range in which the brake system operates while ensuring vehicle driving safety although it requires the replacement or calibration of the vehicle's braking-related parts. A third stage may be set to a range in which the brake system does not operate normally and requires the replacement or calibration of the vehicle's braking-related parts. The third stage may involve an emergency situation that makes it difficult for the brake system to operate normally. The above three stages are set only for ease of explanation, and do not limit the technical idea of the present invention. Accordingly, the criterion for determining whether the brake system is operating normally may be further divided into sub-stages, or may not be divided into distinct stages.

The AI processor 170-1 of the vehicle may monitor the vehicle's brake system based on neural network training. As described above, the neural network may be designed to emulate a human brain's structure on a computer, and may include a plurality of network nodes having weights that emulate neurons in a human neural network. The plurality of network nodes may send and receive data through connections so that they emulate the synaptic activity of neurons sending and receiving signals through synapses. Such a neural network may include a deep learning model, which has evolved from a neural network model. In the deep learning model, the plurality of network nodes are arranged in different layers, and may send and receive data through convolutions. Examples of the neural network model include various deep learning techniques such as deep neural networks (DNN), convolutional deep neural networks (CNN), recurrent neural networks (RNN), restricted Boltzmann machines (RBM), deep belief networks (DBN), and deep Q-networks.

The AI processor of the vehicle may perform neural network training based on information related to factors affecting braking distance while driving the vehicle. The information related to factors affecting braking distance may be related to whether or not the brake system is operating normally. Thus, in order to perform neural network training, the AI processor may receive information related to the vehicle's braking which may affect the operation of the brake system, from devices connected to the autonomous driving system (S1220). The vehicle braking-related information may include at least one among passenger's weight, passenger's location information, vehicle weight, tire air pressure, driving speed, temperature, and road surface conditions. Since each of the factors may affect the braking distance while driving the vehicle, this information may be transmitted to the AI processor.

In a concrete example, information on road surface conditions or the like may be created by using the object detection device 210 of the vehicle 10. Information such as the evenness (roughness) of a road surface, an obstacle's position, and the distance to an object may be obtained by a camera. Alternatively, radio waves may be emitted to the road surface by radar, and road surface condition information may be obtained based on the ToF or phase shift of a carrier wave. Alternatively, laser light is emitted to the road surface by lidar, and road surface condition information may be obtained based on the reflected light.

The sensing unit 270 of the vehicle 10 may create vehicle status data based on a signal created by at least one sensor. In an example, information such as vehicle speed data, vehicle acceleration data, tire air pressure data, vehicle weight data, data on pressures applied to the brake pedal, temperature data, etc. may be created.

The created data including road surface condition information and vehicle status data may be transmitted to the AI processor through the interface unit 180 of the autonomous driving system 260. The AI processor may be included as part of the processor 170 of the autonomous driving system, or may be included in the autonomous driving system, independently from the processor. If the AI processor is included in the autonomous driving system, independently from the processor, an additional memory and/or interface may be present.

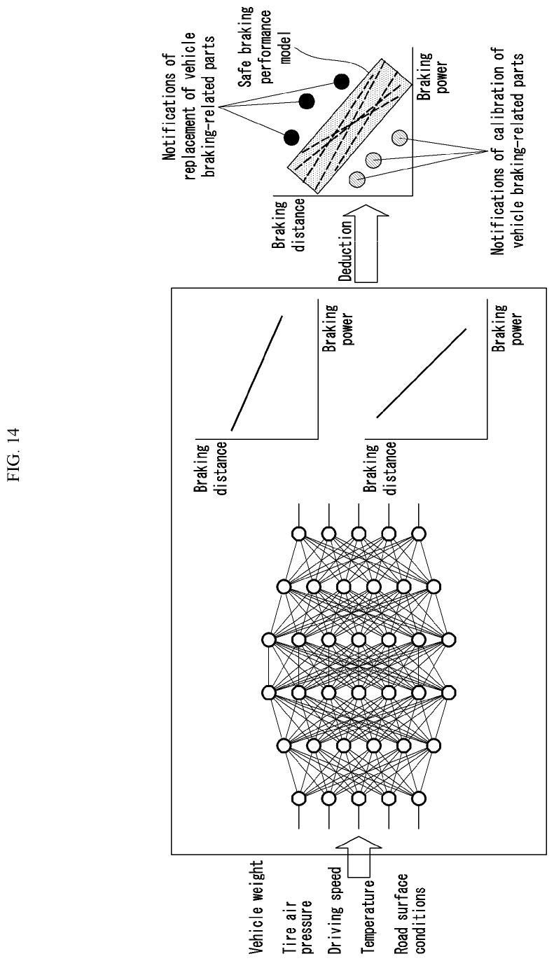

FIG. 14 shows an example of performing monitoring of a brake system through neural network training by using a vehicle's AI processor, to which a method and exemplary embodiment proposed in the present disclosure are applicable. FIG. 14 is merely for illustrative purposes and does not limit the technical idea of the present invention.

Referring to FIG. 14, the AI processor 170-1 may perform neural network training by using a safe braking performance model stored in a memory and information associated with vehicle driving received from devices in the vehicle (S1230).

Determinations may be made on the operation of the vehicle's brake system, based on neural network training results and a criterion (e.g., safe braking performance model) for determining whether the brake system is operating normally (S1240). Specifically, the safety of the vehicle's braking-related parts may be determined. Also, if the vehicle's brake system has a longer braking distance than a set range of the safe braking performance model when it has the same braking power, or, if the vehicle's brake system requires higher braking power to achieve the same braking distance, it may be determined that the vehicle's braking-related parts need to be replaced. Alternatively, if the brake system has a shorter braking distance than a set range of the safe braking performance model when it has lower braking distance, it may be determined that the brake system needs to be calibrated.

The AI processor may give the user feedback about the determination result (S1250).

If the AI processor determines that the vehicle's braking-related parts need to be replaced or calibrated, it may transmit information to the user, including a message asking to replace or calibrate the vehicle's braking-related parts through the vehicle's user interface device. In an example, notifications of the replacement of the vehicle's braking-related parts may be displayed on the vehicle's display device (e.g., HUD, dashboard display, etc.). Alternatively, a message notifying of the replacement of the vehicle's braking-related parts may be displayed by using the vehicle's audio equipment.

In another example, apart from providing the user with feedback about the vehicle's braking-related parts by using the vehicle's display device, audio equipment, etc., the user may be informed of additional information, such as information on a vehicle repair shop for having the vehicle's braking-related parts replaced or calibrated. The information on a vehicle repair shop may include the location of the vehicle repair shop, route information, etc. The user may be given guidance on the location of the closest vehicle repair shop from the current vehicle location or the location of a vehicle repair shop they prefer. Alternatively, a route via the closest vehicle repair shop from the current vehicle location or the location of a vehicle repair shop the user prefers may be set.

In another example, an autonomous vehicle may transmit information on the vehicle's braking-related parts that need to be replaced or calibrated over a wireless communication network (e.g., 5G network). Here, the wireless communication network may include a server or module that performs autonomous driving-related remote control. Also, the wireless communication network may transmit the information on the vehicle's braking-related parts that need to be replaced or calibrated to a repair shop the user prefers or the closest repair shop, and may reserve a vehicle inspection service for replacement or calibration. Moreover, the wireless communication network may receive a vehicle inspection service reservation result from a repair shop and transmit it to the autonomous vehicle.

In another example, in a case where the criterion (e.g., safe braking performance model) for determining whether the brake system is operating normally is set in stages, it may be determined that the brake system is within an abnormal operating range, such as the occurrence of an abrupt situation while driving the vehicle. In an example, the processor may recognize that something corresponding to the third stage of the above safe braking performance model has occurred. In this case, the vehicle may transmit an emergency message to surrounding vehicles using a vehicle network, in order to prevent vehicle accidents. In this instance, the vehicle network may use a wireless communication network. Alternatively, sidelinks with surrounding vehicles may be used. This can reduce the probability of accidents caused by abnormal operation of the brake system.

A concrete example of monitoring the vehicle's brake system and giving feedback to the user will be given according to the above-described exemplary embodiment. It is assumed that the driver is pushing the brake pedal on a rainy day, with two people in the front seats of the vehicle.

The rainy environment and the road surface conditions may be detected by a radar and camera in the vehicle. The sensing part may obtain information such as total vehicle weight (the sum of an empty vehicle weight and two users' weights (e.g., 170 kg)), tire air pressure (PSI37), driving speed of 70 km/h, and a rain sensor (low). The above information (e.g., road surface conditions, total vehicle weight, user location information, tire air pressure, driving speed, rain sensor, etc.) may be transmitted to the AI processor through the interface unit.

The AI processor may perform neural network training based on input information. The AI processor may perform learning while adjusting the weights of elements for each hidden layer by using a deep neural network. Based on the relationship between the braking distance obtained through neural network training and the braking power of the brake system, whether or not the vehicle's brake system is operating within a set range of the safe braking performance model may be determined.

If the vehicle's brake system is not operating within a normal operating range, feedback about relevant information needs to be given to the user. Specifically, if the vehicle's brake system has a longer braking distance than a set range of the safe braking performance model when it has the same braking power, or if the vehicle's brake system requires higher braking power to achieve the same braking distance, it may be determined that the vehicle's braking-related parts need to be replaced. Alternatively, if the brake system has a shorter braking distance than a set range of the safe braking performance model when it has a lower braking power, it may be determined that the brake system needs to be calibrated.

Feedback information such as notifications of the replacement or calibration of the vehicle's braking-related parts may be displayed on the vehicle's display device (e.g., HUD, dashboard display, etc.). Alternatively, feedback information such as notifications of the replacement or calibration of the vehicle's braking-related parts may be displayed by using the vehicle's audio equipment.

The user may be given guidance on the closest vehicle repair shop from the current vehicle location, together with or separately from feedback about the vehicle's braking-related parts. A message may be displayed so that the user selects whether to set a repair shop as a stop-off point or not.

Using a vehicle network, information on the vehicle's braking-related parts that need to be replaced or calibrated may be transmitted to a repair shop the user prefers or the closet repair shop, and a vehicle inspection service for replacement or calibration may be reserved. In this case, a wireless communication network may be used as the vehicle network. Also, a vehicle inspection service reservation result may be received from a repair shop using the vehicle network.

### Exemplary Embodiment 2

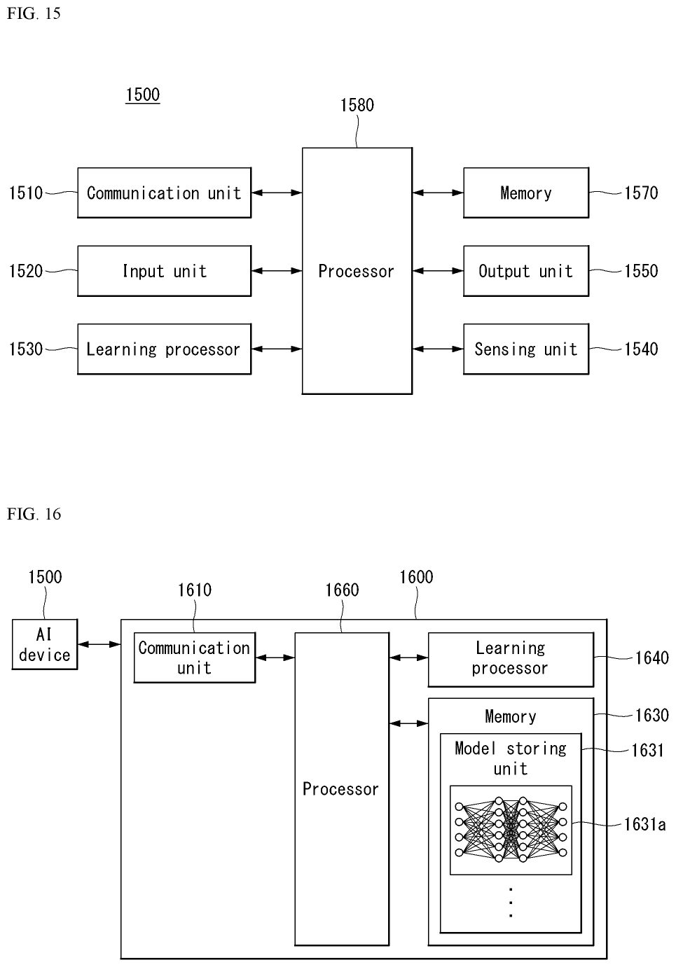

FIG. 15 shows an AI device 1500 according to an exemplary embodiment of the present invention.

The AI device 1500 may be implemented as a stationary device or mobile device, such as a TV, projector, mobile phone, smartphone, desktop computer, laptop, digital broadcasting terminal, PDA (personal digital assistant, PMP (portable multimedia player), navigation, tablet PC, wearable device, set-top box (STB), DMB receiver, radio, washing machine, refrigerator, desktop computer, digital signage, robot, and vehicle.

Referring to FIG. 15, the AI device 1500 may include a communication unit 1510, an input unit 1520, a learning processor 1530, a sensing unit 1540, an output unit 1550, a memory 1570, and a processor 1580.

The communication unit 1510 may send and receive data to and from external devices such as other AI devices 1700a to 1700e or an AI server 1600 by using wired and wireless communication technologies. For example, the communication unit 1510 may send and receive sensor information, user input, a learning model, control signals, etc. to and from external devices.

In this case, the communication technologies used by the communication unit 1510 may include GSM (Global System for Mobile communication), CDMA (Code Division Multi Access), LTE (Long Term Evolution), 5G, WLAN (Wireless LAN), Wi-Fi (Wireless Fidelity), Bluetooth, RFID (Radio Frequency Identification) Infrared Data Association (IrDA), ZigBee, NFC (Near Field Communication), etc.

The input unit 1520 may obtain various kinds of data.

In this instance, the input unit 1520 may include a camera for image signal input, a microphone for receiving audio signals, and a user input unit for receiving information from the user. Here, the camera or microphone is treated as a sensor, and signals obtained from the camera or microphone may be viewed as sensing data or sensor information.

The input unit 1520 may obtain learning data for model training and input data, which is to be used when obtaining output using a learning model. The input unit 1520 may obtain unprocessed input data, in which case the processor 1580 or learning processor 1530 may extract input features as a way of preprocessing input data.

The learning processor 1530 may train a model consisting of an artificial neural network by using learning data. Here, a trained artificial neural network may be referred to as a learning model. The learning model may be used to deduce result values for new input data, not for learning data, and the deduced values may be used as a basis for determining whether to perform a certain task.

In this case, the learning processor 1530 may perform AI processing, along with the learning processor 1640 of the AI server 1600.

In this case, the learning processor 1530 may include a memory integrated with or implemented in the AI device 1500. Alternatively, the learning processor 1530 may be implemented by using an external memory directly connected to the memory 1570 and the AI device 1500 or a memory maintained on an external device.

The sensing unit 1540 may obtain at least one among information on the inside of the AI device 1500, information on the surrounding environment of the AI device 1500, and user information.

In this case, sensors included in the sensing unit 1540 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, lidar, radar, etc.

The output unit 1550 may generate output related to visual, auditory, and tactile senses.

In this case, the output unit 1550 may include a display unit for outputting visual information, a speaker for outputting auditory information, and a haptic module for outputting tactile information.

The memory 1570 may store data that supports various functions of the AI device 1500. For instance, the memory 1570 may store input data, learning data, a learning model, a learning history, etc. that are obtained from the input unit 1520.

The processor 1580 may determine at least one executable task of the AI device 1500, based on information determined or generated by using a data analysis algorithm or machine learning algorithm. Also, the processor 1580 may perform a determined task by controlling the components of the AI device 1500.

To this end, the processor 1580 may request, search for, receive, or use data in the learning processor 1530 or memory 1570, and may control the components of the AI device 1500 so as to execute a predicted task or deemed preferable task, among the at least one executable task.

In this case, the processor 1580 requires a connection with an external device to perform a determined task, it may generate control signals for controlling the external device and transmit the generated control signals to the external device.

The processor 1580 may obtain intended information according to user input and determine the user's requirements based on the obtained intended information.

In this case, the processor 1580 may obtain intended information corresponding to user input by using at least one of an STT (Speech to Text) engine for converting speech input into text and an NLP (Natural Language Processing) engine for obtaining intended information in natural language.

In this case, at least one of the STT engine and the NLP engine may at least partially consist of an artificial neutral network trained according to a machine learning algorithm. Also, at least one of the STT engine and the NLP engine is trained by the learning processor 1530, or may be trained by the learning processor 1640 of the AI server 1600 or trained by their distributed processing.

The processor 1580 may collect history information including the user's feedback on the operational details or operation of the AI device 1500 and store it in the memory 1570 or learning processor 1530 or transmit it to an external device such as the AI server 1600. The collected history information may be used to update a learning model.

The processor 1580 may control at least part of the components of the AI device 1500, in order to drive an application program stored in the memory 1570. Further, the processor 1580 may operate a combination of two or more of the components included in the AI device 1500, in order to drive the application program.

If the AI device is implemented as a mobile device, the AI device may include a brake system to adjust the speed or stop the vehicle. Here, the brake system refers to a system that stops a running vehicle or keeps the vehicle stopped. Since the brake system of the AI device operates by using friction, the AI device's braking-related parts may wear out due to friction. Accordingly, a method of monitoring the brake system of the AI device and giving feedback about monitoring results may be taken into consideration.

To monitor the brake system of the AI device, information related to criteria for determining whether the brake system is operating normally may be stored in the memory 1570 of the AI device 1500. Alternatively, this information may be stored in the memory 1630 of the AI server. The information related to criteria for determining whether the brake system is operating normally may be set based on the speed of the AI device and the braking power and braking distance of the brake system. In an example, the AI device's manufacturer may perform repeated tests to create a safe braking performance model based on the relationship between the braking distance versus AI device speed and the braking power of the brake system. The safe braking performance model may be used as the information related to criteria for determining whether the brake system is operating normally. The safe braking performance model may be used to monitor the AI device's braking-related parts.

The safe braking performance model may be set in stages. For example, a first stage may be set to a range in which the brake system operates normally and does not require the replacement or calibration of parts. A second stage may be set to a range in which the brake system operates while ensuring safety although it requires the replacement or calibration of parts. A third stage may be set to a range in which the brake system does not operate normally. The third stage may involve an emergency situation that makes it difficult for the brake system to operate normally. The above three stages are set only for ease of explanation, and do not limit the technical idea of the present invention. Accordingly, the safe braking performance model may be further divided into sub-stages, or may correspond to the entire normal operating range without being divided into distinct stages.

The AI device may receive information required for neural network training through the input unit 1520. The information required for neural network training may be information related to factors affecting the braking distance of the AI device. Also, the information required for neural network training may be information related to the braking operation of the AI device. In an example, the AI device may receive information related to the weights of the AI device and user, the user's location information, the weight of the AI device, the pressure of the tires, the speed of the AI device, temperatures, road surface conditions, and so on. Alternatively, the AI device may obtain information such as the AI device's speed data, the AI device's acceleration data, tire air pressure data, the AI device's weight data, data on pressures applied to the brake system, temperature data, etc., based on a signal created by at least one sensor of the sensing unit 1540.

The learning processor 1530 may train a model consisting of an artificial neural network based on the safe braking performance model and the information obtained through the input unit and/or sensing unit. Here, a trained artificial neural network may be referred to as a learning model. The learning model may be used to deduce result values for new input data, not for learning data, and the deduced values may be used as a basis for determining whether to perform a certain task.

Based on the deduced values, the processor 1580 may determine whether the AI device's brake system is operating within a normal operating range. Also, the safety of the AI device's braking-related parts may be determined. If the operation of the AI device's brake system is not within an initial set range of the safety braking performance model for the vehicle, it may be determined that the AI device's braking-related parts need to be replaced. Alternatively, if the AI device's brake system has a short braking distance even at a lower braking power compared to a reference model, it may be determined that the brake system needs to be calibrated.

The processor 1580 may give the user feedback about the determination result. If the processor 1580 determines that the vehicle's braking-related parts need to be replaced or calibrated, it may transmit information to the user, such as notifications of when to replace or calibrate the AI device's braking-related parts through the output unit 1550. Specifically, notifications of when to replace or calibrate the vehicle's braking-related parts may be displayed through a display, speaker, etc. included in the output unit 1550.

Information on the AI device's braking-related parts that need to be replaced or calibrated may be transmitted to a repair shop the user prefers or the closet repair shop through the communication unit 1510, or an inspection service for replacement or calibration may be reserved. Also, the communication unit 1510 may receive an inspection service reservation result from a repair shop. In this case, the communication unit 1510 may use a wireless communication network.

In a case where the criterion (e.g., safe braking performance model) for determining whether the brake system is operating normally is set in stages, it may be determined that the brake system is within an abnormal operating range, such as the occurrence of an abrupt situation while driving the AI device. In an example, the processor may recognize that something corresponding to the third stage of the above safe braking performance model has occurred. In this case, the AI device may transmit an emergency message to surrounding AI devices using a wireless communication network, in order to prevent accidents. Alternatively, sidelinks with surrounding AI devices may be used. Alternatively, a corresponding message may be transmitted to surrounding AI devices through the AI server.

FIG. 16 shows an AI server 1600 according to an exemplary embodiment of the present invention.

Referring to FIG. 16, the AI server 1600 may refer to a device that trains an artificial neural network using a machine learning algorithm or uses a trained artificial neural network. Here, the AI server 1600 may consist of a plurality of servers to perform distributed processing, and may be defined as a 5G network. In this case, the AI server 1600 may be included as part of the configuration of the AI device 1500 and perform at least part of AI processing.

The AI server 1600 may include a communication unit 1610, a memory 1630, a learning processor 1640, and a processor 1660.

The communication unit 1610 may send and receive data to and from an external device such as the AI device 1500.

The memory 1630 may include a model storing unit 1631. The model storing unit 1631 may store a model (or artificial neural network) 1631a that is being or has been trained through the learning processor 1640.

The learning processor 1640 may train the artificial neural network 1631a by using learning data. The learning model may be used while mounted on the AI server 1600 of the artificial neural network, or may be used while mounted on an external device such as the AI device 1500.

The learning model may be implemented as hardware, software, or a combination of hardware and software. If part of or the entire learning model is implemented as software, one or more instructions constituting the learning model may be stored in the memory 1630.

The processor 1660 may deduce result values for new input data by using a learning model, and create a response or control instruction based on the deduced result values.

In an example, the communication unit 1610 may send and receive information required for neural network training to and from an external device such as the AI device 1500. Information related to the weights of the AI device and user, the user's location information, the weight of the AI device, the pressure of the tires, the speed of the AI device, temperatures, road surface conditions, and so on may be received from an external device such as the AI device 1500. The learning processor 1640 may train the artificial neural network 1631a by using learning data. A model consisting of an artificial neural network may be trained based on the information received through the safe braking performance model and communication unit. Based on the values deduced through neural network training, the processor 1660 may determine whether the AI device's brake system is operating within a normal operating range. A response or control command may be created based on the determination result and transmitted to the AI device. Alternatively, the values deuced through neural network training may be transmitted to the AI device 1500 through the communication unit 1610.

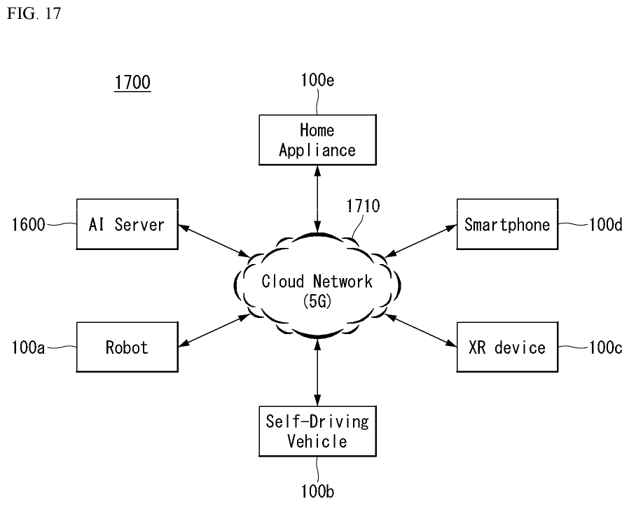

FIG. 17 shows an AI system 1700 according to an exemplary embodiment of the present invention.

Referring to FIG. 17, in the AI system 1700, at least one among the AI server 1600, a robot 100a, a self-driving vehicle 100b, an XR device 100c, a smartphone 100d, and a home appliance 100e is connected to a cloud network 1710. Here, the robot 100a, self-driving vehicle 100b, XR device 100c, smartphone 100d, and home appliance 100e to which AI technology is applied may be referred to as AI devices 100a to 100e.

The cloud network 1710 may refer to a network that constitutes part of a cloud computing infrastructure or exists in the cloud computing infrastructure. Here, the cloud network 1710 may be configured by using a 3G network, 4G or LTE (Long Term Evolution) network, or 5G network.

That is, the devices 100a to 100e and 1600 may be connected together over the cloud network 1710. Particularly, the devices 100a to 100e and 1600 may communicate with one another via a base station or directly without a base station.

The AI server 1600 may include a server that performs AI processing and a server that performs big data tasks.

The AI server 1600 may be connected to at least one of the AI devices constituting the AI system 1700—that is, the robot 100a, self-driving vehicle 100b, XR device 100c, smartphone 100d, and home appliance 100e over the cloud network 1710, and may help the connected AI devise 100a to 100e perform at least part of the AI processing.

In this case, the AI server 1600 may train an artificial neural network in place of the AI devices 100a to 100e according to a machine learning algorithm, and may itself store a learning model or transmit it to the AI devices 100a to 100e.

In this instance, the AI server 1600 may receive input data from the AI devices 100a to 100e, deduce results values for the received input data by using a learning model, and create a response or control command based on the deduced result values and transmit it to the AI devices 100a to 100e.

Alternatively, the AI devices 100a to 100e themselves may deduce result values for input data by using a learning model, and create a response or control command based on the deduced result values.

Hereinafter, various exemplary embodiments of the AI devices 100a to 100e to which the above-described technology is applied will be described. Here, the AI devices 100a to 100e shown in FIG. 3 may be seen as concrete exemplary embodiments of the AI device 1500 shown in FIG. 1.

AI and Robot to which the Present Invention is Applicable

The robot 100a may be implemented as a guide robot, transportation robot, cleaning robot, wearable robot, entertainment robot, pet robot, or unmanned aerial robot, to which AI technology is applied.

The robot 100a may include a robot control module for controlling tasks, and the robot control module may refer to a software module or a hardware-implemented chip thereof.

The robot 100a may obtain status information of the robot 100a, detect (recognize) an environment and objects around it, create map data, determine a movement path or travel plan, determine a response to user interaction, or determine a task, by using sensor information obtained from various kinds of sensors.

Here, the robot 100a may use sensor information obtained from at least one sensor among lidar, radar, and a camera, in order to determine a movement path and a travel plan.

The robot 100a may perform the above tasks by using a learning model consisting of at least one artificial neural network. For instance, the robot 100a may recognize an environment and objects around it by using a learning model, and determine a travel route by using information on the recognized environment or objects around it. Here, the learning model may be trained directly by the robot 100a or trained by an external device such as the AI server 1600.

In this case, although the robot 100a itself may perform a task by creating results using a learning model, it may perform a task by transmitting sensor information to an external device such as the AI server 1600 and receiving results created from it.

The robot 100a may determine a movement path and a travel plan by using at least among map data, object information detected from sensor information, and object information obtained from an external device, and the robot 100a may travel according to the determined movement path and travel plan by controlling its driving unit.

The map data may include object identification information about various objects placed in a space where the robot 100a moves. For example, the map data may include object identification information about fixed objects such as walls, doors, etc. and movable objects such as a flowerpot, desk, etc. The object identification information may include name, type, distance, location, etc.

Moreover, the robot 100a may perform a task or travel by controlling its driving unit based on the user's control/interaction. In this case, the robot 100a may obtain intended information about an interaction via the user's motion or speech, and determine a response based on the obtained intended information and perform a task.

AI and Autonomous Driving to which the Present Invention is Applicable

The self-driving vehicle 100b may be implemented as a mobile robot, vehicle, or unmanned aerial robot, to which AI technology is applied.

The self-driving vehicle 100b may include an autonomous driving control module for controlling autonomous driving functionality, and the autonomous driving control module may refer to a software module or a hardware-implemented chip thereof. The autonomous driving control module may be a component of the self-driving vehicle 100b and included in it, or may be configured as a separate piece of hardware outside the self-driving vehicle 100b.

The self-driving vehicle 100b may obtain status information of the self-driving vehicle 100b, detect (recognize) an environment and objects around it, create map data, determine a movement path or travel plan, determine a response to user interaction, or determine a task, by using sensor information obtained from various kinds of sensors.

Here, the self-driving vehicle 100b, like the robot 100a, may use sensor information obtained from at least one sensor among lidar, radar, and a camera, in order to determine a movement path and a travel plan.

Particularly, the self-driving vehicle 100b may recognize an environment or objects in an area blocked from view or an area located at a given distance or longer by receiving sensor information from external devices, or may receive recognized information directly from external devices.

The self-driving vehicle 100b may perform the above tasks by using a learning model consisting of at least one artificial neural network. For instance, the self-driving vehicle 100b may recognize an environment and objects around it by using a learning model, and determine a task by using information on the recognized environment or objects around it. Here, the learning model may be trained directly by the self-driving vehicle 100b or trained by an external device such as the AI server 1600.

In this case, although the self-driving vehicle 100b itself may perform a task by creating results using a learning model, it may perform a task by transmitting sensor information to an external device such as the AI server 1600 and receiving results created from it.

The self-driving vehicle 100b may determine a movement path and a travel plan by using at least among map data, object information detected from sensor information, and object information obtained from an external device, and the self-driving vehicle 100b may travel according to the determined movement path and travel plan by controlling its driving unit.

The map data may include object identification information about various objects placed in a space (e.g., road) where the self-driving vehicle 100b moves. For example, the map data may include object identification information about fixed objects such as street lights, rocks, buildings, etc. and movable objects such as vehicles, pedestrians, etc. The object identification information may include name, type, distance, location, etc.

Moreover, the self-driving vehicle 100b may perform a task or travel by controlling its driving unit based on the user's control/interaction. In this case, the self-driving vehicle 100b may obtain intended information about an interaction via the user's motion or speech, and determine a response based on the obtained intended information and perform a task.

AI and XR to which the Present Invention is Applicable

The XR device 100c may be implemented as a HUD (head-up display), television, mobile phone, smartphone, computer wearable device, home appliance, digital signage, vehicle, stationary robot, or mobile robot, to which AI technology is applied.

The XR device 100c may obtain information on a space or real-world objet around it by analyzing three-dimensional point cloud data or image data obtained through various sensors or from an external device and creating location data and attribute data for three-dimensional points, and may render and output an XR object. For example, the XR device 100c may output an XR object containing additional information on a recognized object by matching it to the recognized object.

The XR device 100c may perform the above tasks by using a learning model consisting of at least one artificial neural network. For instance, the XR device 100c may recognize a real-world object from three-dimensional point loud data or image data by using a learning model, and provide information corresponding to the recognized real-world object. Here, the learning model may be trained directly by the XR device 100c or trained by an external device such as the AI server 1600.

In this case, although the XR device 100c itself may perform a task by creating results using a learning model, it may perform a task by transmitting sensor information to an external device such as the AI server 1600 and receiving results created from it.

AI, Robot, and Autonomous Driving to which the Present Invention is Applicable

The robot 100a may be implemented as a guide robot, transportation robot, cleaning robot, wearable robot, entertainment robot, pet robot, or unmanned aerial robot, to which AI technology and autonomous driving technology are applied.

The robot 100a to which AI technology and autonomous driving technology are applied may mean a robot with autonomous driving functionality or a robot 100a that interacts with a self-driving vehicle 100b.

The robot 100a with autonomous driving functionality may collectively refer to devices that move on their own along a given route without user control or move along a route determined by themselves.

The robot 100a with autonomous driving functionality and the self-driving vehicle 100b may use a common sensing method to determine one or more between a movement path and a travel plan. For example, the robot 100a with autonomous driving functionality and the self-driving vehicle 100b may determine one or more between a movement path and a travel plan by using information sensed by lidar, radar, and a camera.

The robot 100a interacting with the self-driving vehicle 100b may exist separately from the self-driving vehicle 100b and, at the same time, may be associated with an autonomous driving function inside or outside the self-driving vehicle 100b, or may perform a task associated with a user riding in the self-driving vehicle 100b.

In this case, the robot 100a interacting with the self-driving vehicle 100b may acquire sensor information in place of the self-driving vehicle 100b and provide it to the self-driving vehicle 100b, or may acquire sensor information, create information on the environment or objects around it, and provide it to the self-driving vehicle 100b, thereby controlling or assisting the autonomous driving functionality of the self-driving vehicle 100b.

Alternatively, the robot 100a, while interacting with the self-driving vehicle 100b, may control the functionality of the self-driving vehicle 100b by monitoring a user riding in the self-driving vehicle 100b or interacting with the user. For instance, if the driver is deemed asleep, the robot 100a may enable the autonomous driving function of the self-driving vehicle 100b or assist in controlling the driving unit of the self-driving vehicle 100b. Here, the functions of the self-driving vehicle 100b controlled by the robot 100a may include functions provided by a navigation system or audio system provided inside the self-driving vehicle 100b, as well as the autonomous driving function.

Alternatively, the robot 100a outside the self-driving vehicle 100b, which is interacting with the self-driving vehicle 100b, may provide information to the self-driving vehicle 100b or assist the functions of the self-driving vehicle 100b. For instance, the robot 100a may provide traffic information including signaling information to the self-driving vehicle 100b, like smart traffic lights do, or may automatically connect an electricity charger to a socket by interacting with the self-driving vehicle 100b, like an automatic electricity charger of an electric vehicle does.

AI, Robot, and XR to which the Present Invention is Applicable

The robot 100a may be implemented as a guide robot, transportation robot, cleaning robot, wearable robot, entertainment robot, pet robot, unmanned aerial robot, or drone, to which AI technology and XR technology are applied.

The robot 100a to which XR technology is applied may mean a robot that is controlled and interacted within an XR image. In this case, the robot 100a is distinct from the XR device 100c, and may interact with it.

Once the robot 100a that is controlled and interacted within an XR image obtains sensor information from sensors including a camera, the robot 100a or XR device 100c may create an XR image based on the sensor information, and the XR device 100c may output the created XR image. Also, such a robot 100a may operate based on a control signal inputted through the XR device 100c or based on user interaction.

For example, the user may see an XR image from the point of view of a remotely connected robot 100a through an external device such as the XR device 100c, and may adjust the robot 100a's autonomous driving route via interaction, control tasks or driving, and see information on surrounding objects.

AI, Autonomous Driving, and XR to which the Present Invention is Applicable

The self-driving vehicle 100b may be implemented as a mobile robot, vehicle, or unmanned aerial vehicle, to which AI technology and XR technology are applied.

The self-driving vehicle 100b to which XR technology is applied may mean a self-driving vehicle equipped with a means for providing an XR image or a self-driving vehicle that is controlled and interacted within an XR image. Particularly, the self-driving vehicle 100b that is controlled and interacted within an XR image is distinct from the XR device 100c, and may interact with it.

The self-driving vehicle 100b equipped with a means for providing an XR image may obtain sensor information from sensors including a camera, and output a created XR image based on the obtained sensor information. For instance, the self-driving vehicle 100b may provide an XR object corresponding to a real-world object or on-screen object to a passenger by having an HUD and outputting an XR image on it.

In this instance, when an XR object is outputted on the HUD, at least part of the XR object may overlap a real object where the passenger's gaze is directed. On the other hand, when an XR object is outputted on a display provided inside the self-driving vehicle 100b, at least part of the XR object may overlap an on-screen object. For example, the self-driving vehicle 100b may output XR objects corresponding to objects such as driveways, other vehicles, traffic lights, traffic signs, two-wheel vehicles, pedestrians, buildings, etc.

Once the self-driving vehicle 100b that is controlled and interacted within an XR image obtains sensor information from sensors including a camera, the self-driving vehicle 100b or XR device 100c may create an XR image based on the sensor information, and the XR device 100c may output the created XR image. Also, such a self-driving vehicle 100b may operate based on a control signal inputted through an external device such as the XR device 100c or based on user interaction.

Using the above-described exemplary embodiment and method, brake systems for vehicles and AI devices may be monitored, and the user may be given feedback about information on braking-related parts, thereby ensuring safety.

The aforementioned embodiments have been achieved by combining the elements and characteristics of the present invention in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative, but should be construed as being illustrative from all aspects. The scope of the present invention should be determined by reasonable analysis of the attached claims, and all changes within the equivalent range of the present invention are included in the scope of the present invention.

### INDUSTRIAL APPLICABILITY

While a method for monitoring a vehicle's brake system and giving feedback in an autonomous driving system has been described with respect to an example of sending a feedback message asking to replace or calibrate braking-related parts, this method may be applicable to other various mobile devices and autonomous driving systems.

1. A method for monitoring a vehicle's brake system in an autonomous driving system, the method comprising:
setting criteria information for determining whether the brake system is operating normally;
receiving information related to the vehicle's braking;
performing neural network training based on the braking-related information;
determining whether the brake system is operating normally based on results of the neural network training and the criteria information; and
giving feedback to a user based on the determination.

2. The method of claim 1, wherein the criteria information is set based on the relationship between the speed and braking distance of the vehicle and the braking power of the brake system.

3. The method of claim 2, wherein the criteria information is set in advance by the vehicle's manufacturer.

4. The method of claim 1, wherein the braking-related information comprises at least one among vehicle weight, passenger's weight, passenger's location information, tire air pressure, driving speed, temperature, and road surface conditions.

5. The method of claim 4, wherein information on the road surface conditions is created by using the vehicle's lidar.

6. The method of claim 1, wherein the neural network training is a deep neural network (DNN) method.

7. The method of claim 1, wherein the feedback comprises a message asking to replace or calibrate the vehicle's braking-related parts.

8. The method of claim 7, wherein the feedback is transmitted to the user through either the vehicle's display device or audio equipment.

9. The method of claim 7, wherein the feedback further comprises the location of a vehicle repair shop for having the vehicle's braking-related parts replaced or calibrated and route information.

10. The method of claim 7, further comprising transmitting to a repair shop information on the vehicle's braking-related parts that need to be replaced or calibrated over a wireless communication network.

11. A device for monitoring a vehicle's brake system in an autonomous driving system, the device comprising:
an interface unit for exchanging signals via wires or wirelessly with at least one electronic device provided within the vehicle;
a memory for storing data; and
a processor functionally connected to the memory,
wherein the processor performs control to set criteria information for determining whether the brake system is operating normally, receive information related to the vehicle's braking, perform neural network training based on the braking-related information, determine whether the brake system is operating normally based on results of the neural network training and the criteria information, and give feedback to a user based on the determination.

12. The device of claim 11, wherein the criteria information is set based on the relationship between the speed and braking distance of the vehicle and the braking power of the brake system.

13. The device of claim 11, wherein the braking-related information comprises at least one among vehicle weight, passenger's weight, passenger's location information, tire air pressure, driving speed, temperature, and road surface conditions.

14. The device of claim 11, the feedback comprises a message asking to replace or calibrate the vehicle's braking-related parts.

15. The device of claim 11, wherein the device communicates with at least one among a mobile terminal, a network, and a self-driving vehicle other than the device.
